(19) United States
(12) Patent Application Publication
(10) Pub. No.: US 2021/0090606 A1
(43) Pub. Date: Mar. 25, 2021

(54) MAGNETIC DISK DEVICE

(71) Applicants: Kabushiki Kaisha Toshiba, Tokyo (JP); Toshiba Electronic Devices & Storage Corporation, Tokyo (JP)

(72) Inventor: Yusuke Tomoda, Kawasaki Kanagawa (JP)

(21) Appl. No.: 16/746,084

(22) Filed: Jan. 17, 2020

(30) Foreign Application Priority Data
Sep. 19, 2019 (JP) 2019-170914

(51) Int. Cl. G11B 20/12; G11B 5/09

(52) U.S. Cl. CPC G11B 20/1217; G11B 2020/1292; G11B 2020/1238; G11B 5/09

(57) ABSTRACT

In one embodiment, a magnetic disk device includes a disk with a recording surface, and a head. The recording surface includes a first area including a plurality of track groups in each of which data is recorded while a part of the data is overlappingly recorded, a second area provided separately in an outer circumference side from the first area, and including a plurality of track groups different from the first area in each of which data is recorded while a part of the data is overlappingly recorded, and a third area adjacent to the first area and the second area in a radial direction, and including a plurality of tracks which are arranged at a prescribed interval between the tracks. The head overlappingly records the data in the track groups of the first area in an order from the track locating at a center side to the track locating at the circumference side, and overlappingly records the data in the track groups of the second area in an order from the track locating at the circumference side to the track locating at the center side.

### CROSS-REFERENCE TO RELATED APPLICATION

This application is based upon and claims the benefit of priority from the prior Japanese Patent Application No. 2019-170914, filed on Sep. 19, 2019, the entire contents of which are incorporated herein by reference.

### FIELD

Embodiments described herein relate generally to a magnetic disk device.

### BACKGROUND

There is a magnetic disk device which uses a disk having an SMR (Shingled-write Magnetic Recording) area (or a shingled-write magnetic recording area, hereinafter called an SMR area), and a media cache (Media Cache) area (hereinafter, called an MC area) which is used as a cache for data to be recorded in the SMR area. A track density of the SMR area is higher compared with a track density of the MC area.

In the MC area, recording (writing) of data is performed at a higher frequency than the SMR area. Data recorded in a track in the SMR area adjacent to the MC area is likely to receive interference by a recording magnetic field generated each time the recording is executed to the MC area. As a result, the data may be deteriorated or rewritten, and thereby there is a possibility that reliability of the recorded data is decreased.

### BRIEF DESCRIPTION OF THE DRAWINGS

FIG. 1 is a block diagram showing a main portion of a magnetic disk device according to a first embodiment.

FIG. 2 is a schematic diagram for explaining a configuration of the recording surface of the disk of the magnetic disk device according to the first embodiment.

FIG. 3 is a schematic diagram showing an arrangement of the MC area and the SMR area and a forward direction of the band on the recording surface of the disk of the magnetic disk device according to the first embodiment.

FIG. 4 is a schematic diagram for explaining a configuration of a recording surface of a disk of a magnetic disk device according to a second embodiment.

FIG. 5 is a schematic diagram showing a configuration of a recording surface of a disk of a magnetic disk device according to a comparative example.

FIG. 6 is a schematic diagram showing an arrangement of the MC area and the SMR area and a forward direction of the band on the recording surface of the disk of the above-described comparative example.

### DETAILED DESCRIPTION

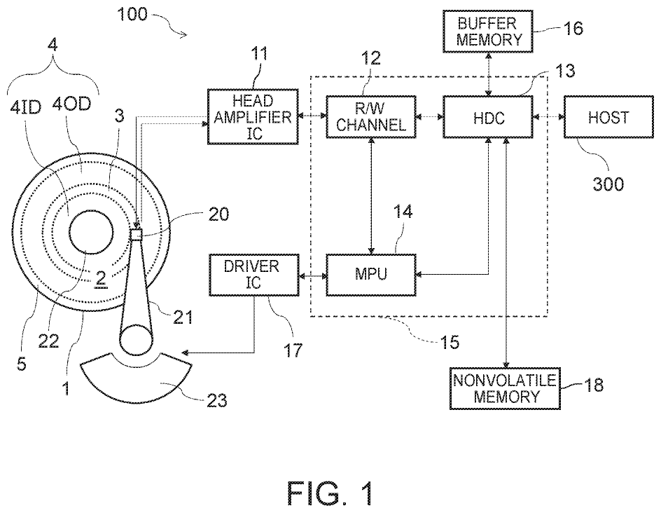

According to one embodiment, a magnetic disk device includes a disk with a recording surface, and a head. The recording surface includes a first area including a plurality of track groups in each of which data is recorded while a part of the data is overlappingly recorded, a second area provided separately in an outer circumference side from the first area, and including a plurality of track groups different from the first area in each of which data is recorded while a part of the data is overlappingly recorded, and a third area adjacent to the first area and the second area in a radial direction, and including a plurality of tracks which are arranged at a prescribed interval between the tracks. The head overlappingly records the data in the track groups of the first area in an order from the track locating at a center side to the track locating at the circumference side, and overlappingly records the data in the track groups of the second area in an order from the track locating at the circumference side to the track locating at the center side.

[First embodiment] A configuration of a magnetic disk device 100 according to a first embodiment will be described using FIG. 1. FIG. 1 is a block diagram showing a main portion of the magnetic disk device 100 according to the first embodiment.

As shown in FIG. 1, the magnetic disk device 100 of the present embodiment has a disk 1, a head amplifier IC 11, a system controller 15 composed of an integrated circuit of one chip, a buffer memory 16, a driver IC 17, a nonvolatile memory 18, a head 20, an arm 21, a spindle motor 22, a voice coil motor 23.

In addition, the magnetic disk device 100 is connected to a host 300 that is an external device. The host 300 is a server or the like, for example, and is a computer which issues a command for making the magnetic disk device 100 perform a desired operation. The host 300 transmits a recording (writing) command and a reproduction (reading) command, for example, to the magnetic disk device 100.

The disk 1 is a disk-like recording medium such as an aluminum substrate and a glass substrate, and has a recording surface 2 coated with magnetic substrate on one surface or the both surfaces thereof. A plurality of tracks for recording data are concentrically provided on the recording surface 2. The number of the disks 1 is not limited to one, but a plurality of the disks 1 may be provided. Taking the case of a plurality of the disks 1 as an example, a plurality of the disks 1 are attached to a rotary shaft of the spindle motor 22 at a prescribed interval therebetween, and are integrally rotated by the drive of the spindle motor 22. For each of the recording surfaces 2, the magnetic head 20 and the arm 21 are correspondingly provided. In FIG. 1, among a plurality of the disks 1, the disk 1 at the upper side, and the magnetic head 20 and the arm 21 corresponding to the recording surface 2 which the disk 1 has are shown.

The arm 21 and the voice coil motor 23 composes an actuator. That is, the actuator enables the arm 21 to move by the drive of the voice coil motor 23, and thereby moves the head 20 to be held by the arm 21 to a position (track) on the recording surface 2 where data is to be recorded/reproduced in a radial direction of the disk 1.

The head 20 has a recording head and a reproduction head. The reproduction head reproduces the data recorded in the track of the recording surface 2, and outputs a reproduced reproduction signal to the head amplifier IC 11. The recording head generates a recording magnetic field based on the recording signal received from the head amplifier IC 11, and records data in a track of the recording surface 2.

The head amplifier IC 11 has a reproduction amplifier and a recording driver. The reproduction amplifier amplifies the reproduction signal read by the reproduction head, and transmits the amplified reproduction signal to a read/write channel (R/W channel) 12. On the other hand, the recording driver transmits a recording signal in according with the recorded data to be outputted from the R/W channel 12 to the recording head.

The system controller 15 includes the R/W channel 12, a hard disk controller (HDC) 13, a microprocessor (MPU) 14.

The R/W channel 12 executes a signal processing to the reproduction data inputted from the head amplifier IC 11 and outputs the signal processed data to the HDC 13, and executes a signal processing to the recorded data inputted from the HDC 13 and outputs the signal processed data to the head amplifier IC 11.

The HDC 13 controls data transfer between the host 300 and the R/W channel 12 in accordance with an order of the MPU 14. The HDC 13 controls the buffer memory 16, temporarily records and holds the reproduction data and the recorded data in the buffer memory 16, and thereby executes data transfer control. For example, when the host 300 is a sever, regarding the data from the server, the system controller 15 performs writing/reading control of the data to the magnetic disk device 100, and the whole devices shown in FIG. 1 configure a storage system. In addition, a storage system may be configured in which not only one magnetic disk device 100 in this manner, but a plurality of the magnetic disk devices 100 are connected to the server via a network, for example.

The MPU 14 is a main controller, controls the voice coil motor 23 via the driver IC 17, and executes a servo control for performing positioning of the head 20. The MPU 14 controls a recording operation of data to the disk 1. Here, a recording system by the control of the MPU 14 includes a CMR (Conventional Magnetic Recording) system that is a regular recording system described later, and an SMR (Shingled-write Magnetic Recording) system. The MPU 14 controls in what area on the recording surface 2 the head 20 records data by the SMR system or the CMR system, in accordance with the control information recorded in a system area on the recording surface 2 of the disk 1.

The buffer memory 16 is a semiconductor memory such as a Dynamic Random Access Memory (DRAM), a Static Random Access Memory (SRAM), or the like which temporarily records data and so on which are transmitted/received between the magnetic disk device 100 and the host 300.

The nonvolatile memory 18 is a semiconductor memory which can hold recorded data even when power supply is cut off, and can hold system information and a control program of the magnetic disk device 100. The nonvolatile memory 18 is a Read Only Memory (ROM), for example.

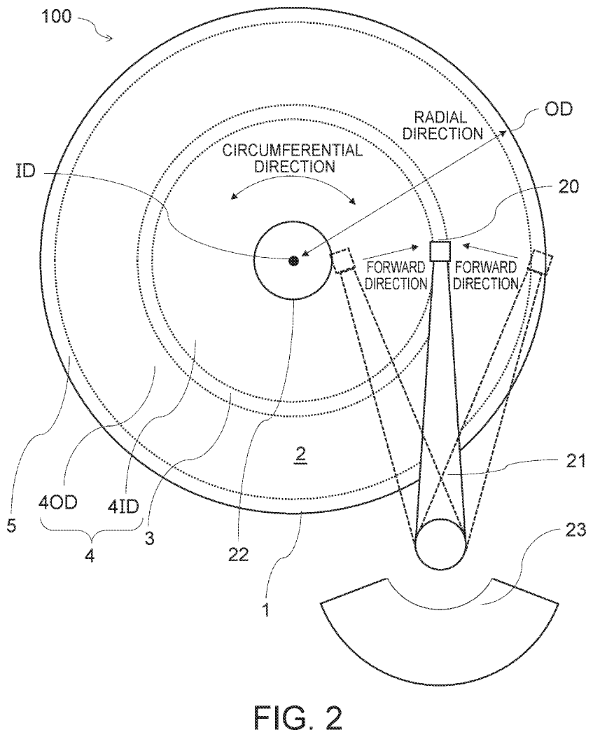

A configuration of the recording surface 2 and data area arrangement will be described using FIG. 2. FIG. 2 is a schematic diagram showing a configuration of the recording surface 2 according to the first embodiment. In FIG. 2, a circumferential direction is a rotation direction of the disk 1 or a direction along an outer circumference of the disk 1, on the recording surface 2 of the disk 1. A radial direction is a direction connecting a center ID of the disk 1 and an outer circumference OD of the disk 1, on the recording surface 2 of the disk 1. In the radial direction, an outward direction is a direction from the center ID toward the outer circumference OD, and an inward direction is a direction from the outer circumference OD toward the center ID. The circumferential direction and the radial direction are defined for the respective positions on the disk 1, and are not respectively expressed as definite vectors on the disk 1.

An MC area 3, an SMR area 4, the system area 5 are assigned on the recording surface 2 of the disk 1. The SMR area 4 is divided into two areas of an SMR area 41D located at the center ID side of the disk 1, and an SMR area 40D located at the outer circumference OD side of the disk 1, across the MC area 3 in the radial direction. The system area 5 is provided at a further outer circumference side of the SMR area 40D.

As described above, the arm 21 moves on the recording surface 2, and thereby the magnetic head 20 at the tip opposite to the recording surface 2 becomes able to record data in tracks of the above-described MC area 3, the SMR area 4 and so on on the recording surface 2, and becomes able to reproduce data from the tracks of these areas.

The MC area 3 as used as a cache to temporarily hold the data recorded in the SMR area 4, or the data to be recorded from now. User data which is requested to be recorded by the host 300, such as sequential data and so on, recorded in the SMR area 4.

In the MC area 3, a plurality of tracks each for recording data are respectively provided at a prescribed interval therebetween. In the present specification, a system to record data respectively in adjacent tracks at an interval therebetween is called a CMR system (a regular recording system). The MC area 3 is a CMR area (a regular recording area) in which data is recorded by the CMR system. The MPU 14 makes the data recorded temporarily in the MC area 3 to be recorded in the SMR area 4 at a prescribed timing. For example, random access data or the like not directly recorded in the SMR area 4, but is temporarily recorded in the MC area 3, and after a prescribed amount of recording data has been recorded in the MC area 3, the relevant data is collectively recorded in the SMR area 4.

The SMR area 4 is a recording area in which an adjacent track next recorded is overwritten, on a part of a certain track. In the present specification, a system to overlappingly record a certain track on a part of an adjacent track is called an SMR system. Since a part of the track is overlappingly recorded, a track density (TPI: Track Per Inch) of the SMR area 4 is higher than a track density of the MC area 3 in which overwriting is not performed. Directions of arrows stated in the SMR areas 41D, 40D respectively show forward directions described later.

In the system area 5, data for controlling recording and reproduction of data to the relevant recording surface 2, and other operation information is recorded. Recording data in the system area 5 is realized by the CMR system, for example.

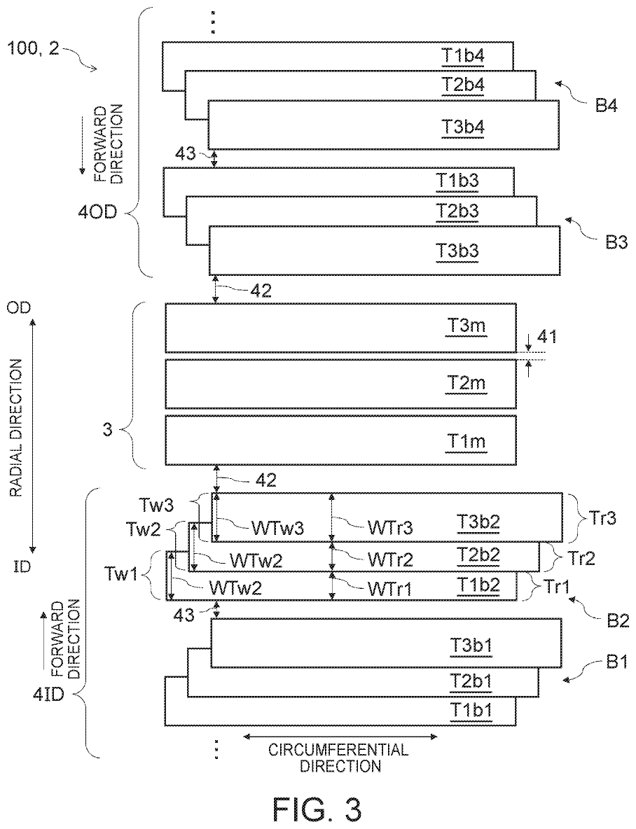

FIG. 3 is a schematic diagram showing an example of an arrangement of the MC area 3 and the SMR area 4 in the recording surface 2, and directions (forward directions) for recording tracks in the SMR areas 41D, 40D, and parts of the SMR areas 4 adjacent to the MC area 3 on the recording surface 2 are cut out, and thereby bands B1-B4 each including tracks of a prescribed unit are shown. In addition, in FIG. 3, for the convenience of explanation, a circumference portion of a partial area in the vicinity of the above-described MC area 3 is linearly expanded, and in FIG. 3, the horizontal direction of the figure shows a circumferential direction of the disk 1, and the vertical direction of the figure shows a radial direction of the disk 1, by deformation. In FIG. 3, in each track, displacement or the like due to the effect of disturbance and other structure is adjusted. In addition, for the convenience of explanation, the track of the SMR area 4 is not overlappingly recorded at the both ends expressed in the figure.

It has been described that each of the bands B1-B4 includes three tracks in FIG. 3, but the each band may include at least two or more tracks. It has been described that the MC area 3 includes three tracks, but the MC area 3 may include a track with a capacity capable of recording data of at least one band portion. In addition, a width of the track is a length in a radial direction of each track.

The MC area 3 has tracks Tim, T2m, T3m in order from the center ID side to the outer circumference OD side. An order in which the tracks Tim, T2m, T3m are recorded by the CMR system is not limited, but these tracks are recorded from the center ID side to the outer circumference OD side, for example. Intervals 41 with a prescribed width are respectively provided between the tracks Tim, T2m, T3m.

Each of the SMR areas 41D, 40D has bands. The band is a track group in which a plurality of tracks are overwritten. In FIG. 3, the four bands B1, B2, B3, B4 which are located in the vicinity of the MC area 3 are extracted and stated. The bands B1, B2 are included in the SMR area 41D. The bands B3, B4 are included in the SMR area 40D.

The bands B1, B2, the MC area 3, the bands B3, B4 align in the stated order, that is, in the order from the center ID side to the outer circumference OD side, and are adjacent to each other. In order to prevent overwriting and interference, an interval 42 with a prescribed width is provided between the adjacent MC area 3 and the band, and an interval 43 with a prescribed width is provided between the adjacent bands.

Each of the bands B1-B4 have tracks Tnbm (n=1−3, m=1−4) which have been overwritten in order, in the radial direction, respectively. In this example, firstly, data is recorded in the track (shingled-write magnetic recording track) of T1bm, secondly data is recorded in the track (shingled-write magnetic recording track) of T2bm, and finally data is recorded in the track (final track) of T3bm. The shingled-write magnetic recording track is a track, in a certain band, a part of which is overwritten by the adjacent neatly recorded track. Accordingly, the shingled-write magnetic recording track is overwritten by a part of another track, but the final track is a track which is not overwritten by another track.

Hereinafter, a track in which the head 20 has recorded data on the disk 1 is called a recorded track Tw. In addition, an area of the recorded track Tw which is remaining except an area which is overwritten by the overwriting of the adjacent track is called a reproduction track Tr. In addition, a term called “track” is sometimes used as a term including “a recorded track” and “a reproduction track”.

For making explanation simple, in FIG. 3, symbols are only described to the recorded tracks and the reproduction tracks of the tracks T1b2, T2b2, T3b2 which the band B2 has. Recorded tracks of the tracks T1bm, T2bm, T3bm are respectively written as Tw1, Tw2, Tw3. Recorded track widths of the tracks T1bm, T2bm, T3bm are respectively written as WTw1, WTw2, WTw3. Reproduction tracks of the tracks T1bm, T2bm, T3bm are respectively written as Tr1, Tr2, Tr3. Reproduction track widths of the tracks T1bm, T2bm, T3bm are respectively written as WTr1, WTr2, WTr3.

The final track (T3bm) is not overwritten by another track. For the reason, the reproduction track width WTr3 of the final track is larger than the reproduction track widths WTr1bm, WTr2bm of the shingled-write magnetic recording tracks.

A direction of a radial direction of a position of the final track (T3bm) from the shingled-write magnetic recording tracks (T1bm, T2bm) of the same band is called a forward direction. In other word, regarding the forward direction, an order in which the head 20 records data in the tracks of a certain band is expressed by a direction in the radial direction.

The forward direction of the bands B1, B2 included in the SMR area 41D is an outward direction. In the bands B1, B2, data are respectively overwritten in the order from the tracks T1b1, T1b2 at the center ID side to the tracks T3b1, T3b2 at the outer circumference OD side. The forward direction of bands B3, B4 included in the SMR area 40D is an inward direction. In the bands B3, B4, data are respectively overwritten in the order from the tracks T1b3, T1b4 at the outer circumference OD side to the tracks T3b3, T3b4 at the center ID side. In this manner, the bands B2, B3 are adjacent to the MC area 3 at the final tracks (T3b2 and T3b3) side.

Data recorded in a certain track receives interference by the recording magnetic field generated when data is recorded in another adjacent track. Regarding the shingled-write magnetic recording track, since data is recorded in an adjacent track in the same band, after data is recorded in the relevant track, recording quality (a signal-to-noise ratio (SN ratio), a bit error rate, for example) thereof is lower than the final track. Since the shingled-write magnetic recording track originally has a low recording quality, when having further received the interference, the shingled-write magnetic recording track is more likely to generate reproduction error than the final track. On the other hand, when having received the interference, the final track is more unlikely to generate reproduction error than the shingled-write magnetic recording track.

Reason in which the forward directions of the SMR areas 41D, 40D are different will be described.

A recording magnetic field applied to the recording surface 2 from the both end portions of the head 20 is weaker than a recording magnetic field applied to the recording surface 2 from the central portion of the head 20. For the reason, at each of the both ends of a track, an area called a fringe in which a direction of magnetization is not uniform (not suitable for reproduction) is formed. Generally, regarding each of the fringes at the both sides of a track, a width thereof changes in accordance with a skew angle (a tilt of the head 20 and the arm 21 on the relevant track to the circumferential direction of the track) of the head 20. Since the head 20 and the arm 21 tilt in accordance with a position in the radial direction of the track where the head 20 and the arm 21 are positioned, a width of the fringe changes in accordance with the position of the track in the radial direction. Generally, in the area at the center ID side of the recording surface 2, the fringe at the center ID side of the track becomes smaller, and in the area at the outer circumference OD side of the recording surface 2, the fringe at the outer circumference OD side of the track becomes smaller. The forward direction is changed between the outer circumference OD side and the center ID side of the recording surface 2, and thereby a smaller one of the fringes to be formed at the both ends of the track is left, and accordingly, it is possible to enhance the recording quality of the reproduction track.

It will be described that a track adjacent to the MC area 3 receives interference by the recording of data into the MC area 3.

In the magnetic disk device 100 using the SMR system, when data is recorded in a band in which data has been recorded already, when data recorded in the SMR area 4 is modified, or when refresh recording is performed, the data recorded already is temporarily recorded and saved in the MC area 3 so that the data recorded in the band is not overwritten and deleted. The saved data is recorded in a band of a recording object at a prescribed timing.

In addition, when data is recorded in the SMR area 4, the data is once recorded in the MC area 3, and then the data is collectively recorded in the SMR area 4 in units of bands. By this means, the magnetic disk device 100 can suppress saving and rewriting of the data in units of bands which are caused by the newly recording of data in a band of the SMR area 4, and can suppress decrease of response (hereinafter, may be expressed simply as response) to the recording/reproduction command received from the host 300. In addition, the case of recording consecutive data with a large capacity is not limited to this.

In this manner, in the magnetic disk device 100 using the SMR system, a frequency at which data is recorded in the MC area 3 is higher than a frequency at which data is recorded in the SMR area 4, due to its characteristics The tracks T3b2, T3b3 of the bands B2, B3 adjacent to the MC area 3 which are respectively adjacent to the MC area 3 receive interference by the recording magnetic field to be generated when the head 20 records data in the MC area 3. Since the tracks T3b2, T3b3 adjacent to the MC area 3 repeatedly receive interference at a high frequency, the recording quality thereof is more likely to be decreased than the tracks not adjacent to the MC area 3.

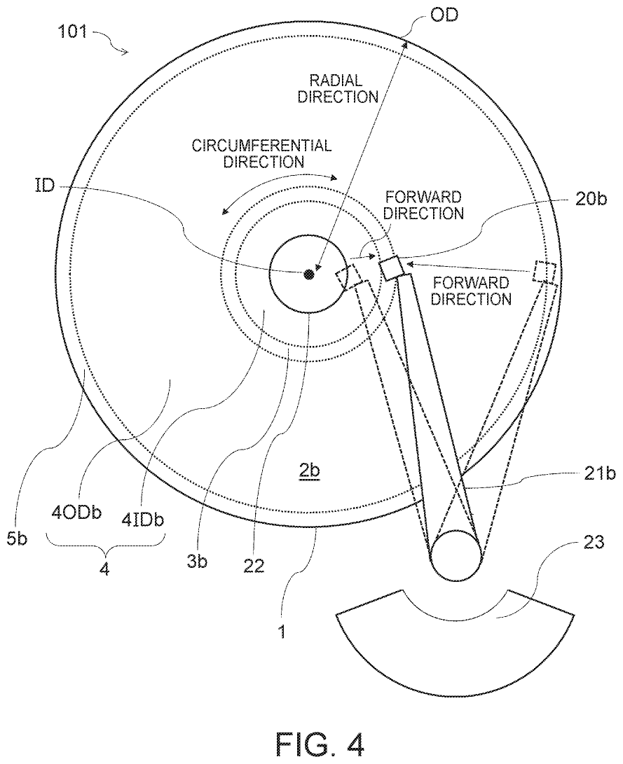

However, each of the tracks T3b2, T3b3 is the final track, and is not overwritten by the adjacent track of the same band, and accordingly, the recording quality thereof is originally higher than the shingled-write magnetic recording track. For the reason, in each of the tracks T3b2, T3b3, the recording quality thereof is unlikely to be decreased by the interference to a level in which the normal data reproduction is impossible. In other words, It is possible to reproduce the data normally at the tracks T3b2 and T3b3. In the magnetic disk device 100 of the first embodiment, the final track (T3b2, T3b3) of the band is determined as the track adjacent to the MC area 3 which is likely to receive interference, and thereby it is possible to improve reliability of the data recorded on the recording surface 2.

[Second embodiment] In a second embodiment, an arrangement of the MC area 3 and the SMR area 4 is different for each the recording surface 2. In the second embodiment, for the convenience of explanation, the recording surface 2 similar to that stated in FIG. 2 is called a recording surface 2a. A magnetic disk device 101 of the second embodiment is different from the first embodiment in a point that in addition to the recording surface 2a, a recording surface 2b different from the recording surface 2a is further provided. The recording surfaces 2a, 2 b can be provided on the same disk 1, or can be provided on the different disks 1. The same symbols are given to the configuration components common to the first embodiment and the second embodiment, and the description thereof will be omitted. FIG. 4 is a schematic diagram showing a configuration of the recording surface 2b of the disk 1 of the magnetic disk device 101 according to the second embodiment.

The widths of the fringes formed at the both ends of the track are not decided uniformly in accordance with the position of the head 20 in the radial direction. Actually, the width of the fringe is affected by manufacturing error such as an error of a mounting position of the head 20 to the arm 21, and amounts of the recording magnetic field strengths at the both ends of the head 20. A switching position (a position where an MC area 3b is provided) of the forward direction for making an effect of the fringe minimum is different for each the recording surface 2.

In the second embodiment, in consideration of the effect of the fringe, the forward direction is switched at an optimum positon for each the recording surface 2, and thereby it is possible to enhance the recording quality of the reproduction track of each the recording surface 2. For example, FIG. 4 shows an example in which errors are generated in a mounting position and a mounting angle of a head 20b corresponding to the recording surface 2b to an arm 21b. Between the head 20a in which a mounting error is not generated, and the head 20b in which a mounting error is generated, the relation between the skew angle and the position of the track in the radial direction is different. For the reason, in the recording surface 2b, a switching position of the forward direction for making the effect of the fringe minimum is set to a position different from that of recording surface 2a. Further, the positions of the MC area 3b, SMR area 41Db, 40Db which are to be provided on the recording surface 2b are different from the positions of the corresponding configuration on the recording surface 2a.

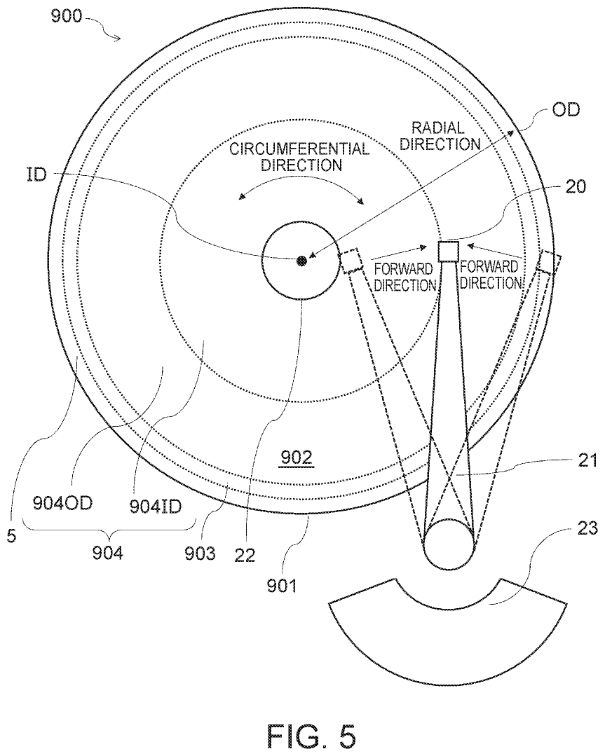

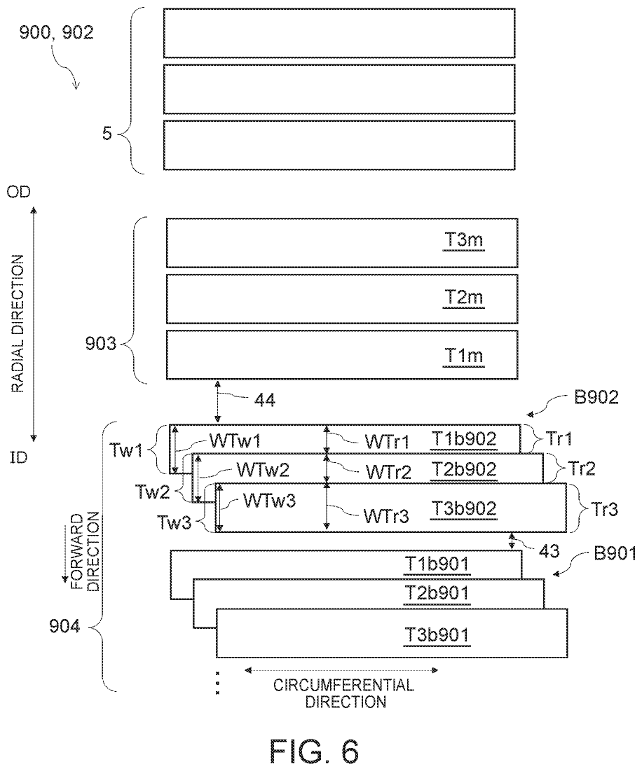

The magnetic disk device 101 of the second embodiment can improve reliability of the data, similarly as the first embodiment, and further, the MC area 3 and the SMR area 4 are arranged at different positions for each the recording surface 2, and thereby it is possible to enhance the recording quality of the reproduction track of each the recording surface 2.

[Comparative example] Next, a magnetic disk device 900 according to a comparative example will be described, using FIG. 5 and FIG. 6.

The magnetic disk device 900 of the comparative example is different from the magnetic disk device 100 of the first embodiment in the arrangement of the data areas in a recording surface 902. The same symbols are given to the configuration components common to the magnetic disk device 100 and the magnetic disk device 900, and the description thereof will be omitted. FIG. 5 is a schematic diagram showing a configuration of the recording surface 902 of a disk 901 of the magnetic disk device 100 according to the comparative example. FIG. 6 is a schematic diagram showing an arrangement of an MC area 903 and an SMR area 904, and a forward direction of the band according to the disk 901 of the above-described comparative example.

On the recording surface 902 of the disk 901, an SMR area 904ID, an SMR area 9040D, an MC area 903, the system area 5 are adjacently arranged in the stated order from the center ID side to the outer circumference OD side. A forward direction of the SMR area 904ID is an outward direction. A forward direction of the SMR area 9040D is an inward direction.

In FIG. 6, the system area 5 and a part of the SMR area 904 which are adjacent to the MC area 903 of the recording surface 902 are cut out and shown. In FIG. 6, two bands B901, B902 which the SMR area 9040D has are cut out and shown. The band B901, B902, the MC area 903 are aligned in the stated order from the center ID side to the outer circumference OD side, and are adjacent to each other. Between the MC area 3 and the adjacent band, a gap 44 of a prescribed width is provided.

The MC area 903 wherein a frequency at which data is recorded is high is arranged at the outer circumference OD side from the SMR area 904. On the recording surface 902, a track located at the outer circumference OD side has a long circumference, and accordingly, data amount which can be recorded for each the track is many. By this means, when data is recorded in the MC area 903, the number of movements of the head 20 between tracks, a time required for the movement, and a time required for recording data are decreased, but an average seek distance of the head 20 between the MC area 903 and the SMR area 904 becomes about a half of the outermost diameter of the disk 901, and thereby the movement thereof becomes the latest.

Further, in the magnetic disk device 900 of the comparative example, the track adjacent to the MC area 903 is a shingled-write magnetic recording track (T1b902). The track T1b902 receives interference when data is recorded in an adjacent track T2b902 of the same band, and thereby the recording quality thereof is low. For the reason, the recording quality of the track T1b902 is likely to be decreased by the interference generated by the recording of data in the MC area 3 to a level in which the normal data reproduction is impossible.

As a measure against decrease of the recording quality, the magnetic disk device 900 of the comparative example requires measures such as to broaden an interval between the MC area 903 and the adjacent band B902, or to perform refresh recording (rewriting data) of the band (B902) adjacent to the MC area 903 at a high frequency.

The interval between the MC area 903 and the adjacent band B902 is broadened, and thereby when data is recorded in the MC area 903, a strength of the recording magnetic field which the track (T1b902) adjacent to the MC area 903 receives becomes small. But an area for recording data on the recording surface 902 is decreased, and thereby the recording capacity of the magnetic disk device 900 is decreased.

The refresh recording is performed at a high frequency, and accordingly, before the track (T1b902) receives interference such that the data recorded in the track (T1b902) adjacent to the MC area 903 cannot be reproduced, it is possible to re-record data recorded in the relevant track. However, at the time of the refresh recording in the SMR, since data is re-recorded not by a track unit but in units of bands, a time required for the refresh recording is long. Since the recording/reproduction command received from the host 300 cannot be executed during the refresh recording, there is a problem that the response of the magnetic disk device 900 is decreased by the refresh recording at a high frequency.

Hereinafter, comparing with the magnetic disk device 900 of the comparative example, it will be described that the magnetic disk devices of the first and the second embodiments can improve reliability of the data recorded in the SMR area, and can suppress decrease of the response by the refresh recording.

In the magnetic disk device of the first embodiment, the final track with high original recording quality is adjacent to the MC area 3, the recording quality of the relevant track is unlikely to decrease to a level such that reproduction of the normal data is impossible, and reliability of the data is high. And intervals between the MC area 3 and the adjacent bands B2, B3 of the SMR area 4 can be made small, and thereby the recording capacity can be made large. In addition, comparing with the magnetic disk device 900 of the comparative example, in the magnetic disk devices of the first and the second embodiments, a frequency of performing refresh recording of the bands adjacent to the MC area 3 can be decreased, and thereby it is possible to suppress the decrease of response of the magnetic disk device.

In the magnetic disk devices of the first and the second embodiments, the MC area 3 is located between the SMR areas 41D, 40D. For the reason, in the first embodiment, when the SMR area 4 is seen as a whole, a distance from the MC area 3 onto an optional track of the SMR area 4, and a time required for the head 20 to move this distance are shorter than the comparative example. For the reason, a time required for the head 20 to perform a series of motions of performing recording/reproduction of data from the MC area 3 to the SMR area 4, or from the SMR area 4 to the MC area 3 is decreased. Accordingly, the response of the magnetic disk device is improved.

As described above, according to the first embodiment or the second embodiment, it is possible to provide the magnetic disk device which can improve reliability of the data recorded in the SMR area, and can suppress decrease of the response.

While certain embodiments have been described, these embodiments have been presented by way of example only, and are not intended to limit the scope of the inventions. Indeed, the embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device, comprising:
a disk with a recording surface,
the recording surface including
a first area including a plurality of track groups in each of which data is recorded while a part of the data is overlappingly recorded,
a second area provided separately in an outer circumference side from the first area, and including a plurality of track groups different from the first area in each of which data is recorded while a part of the data is overlappingly recorded, and
a third area adjacent to the first area and the second area in a radial direction, and including a plurality of tracks which are arranged at a prescribed interval between the tracks; and
a head which overlappingly records the data in the track groups of the first area in an order from the track locating at a center side to the track locating at the circumference side, and overlappingly records the data in the track groups of the second area in an order from the track locating at the circumference side to the track locating at the center side.

2. The magnetic disk device according to claim 1, wherein:
the disk includes a plurality of disks; and
the third areas of the recording surfaces of the respective disks are provided at different positions for the respective recording surfaces in the radial direction of the disk.

3. The magnetic disk device according to claim 2, wherein:
the third area is a media cache area which temporarily records the data to be recorded in the first area and the second area.

4. The magnetic disk device according to claim 3, further comprising:
control means which is to be connected to an external device, and performs control so that the head records the data in the third area in accordance with a recording command transmitted from the external device, and records the data recorded in the third area in the first area or the second area.

5. The magnetic disk device according to claim 4, wherein:
the control means is a system controller including an R/W channel, a hard disk controller, and a microprocessor.

6. A magnetic disk device, comprising:
a disk including a plurality of recording surfaces,
the recording surface including
a first area including a first track, and a second track with a larger width in a radial direction than the first track, while the second track being overwritten on a part of the first track at the center side, and
a second area adjacent to the center side of the first area, and including a plurality of third tracks provided with a prescribed interval between the tracks; and
a head which records or reproduces data in or from the first area and the second area.

7. The magnetic disk device according to claim 6, wherein:
the second track is adjacent to the second area.

8. The magnetic disk device according to claim 7, wherein:
the recording surface further includes a third area adjacent to the center side of the second area, and including a fourth track, and a fifth track with a larger width in the radial direction than the fourth track, while the fifth track is overwritten on a part of the fourth track at an outer circumference side.

9. The magnetic disk device according to claim 8, wherein:
a position in the radial direction where the second area is provided is different for each the recording surface.

10. A magnetic disk device, comprising:
a disk including a first shingled-write magnetic recording area, a second shingled-write magnetic recording area located at an outer circumference side of the first shingled-write magnetic recording area, and a regular recording area located between the first shingled-write magnetic recording area, and the second shingled-write magnetic recording area; and
a head which records data in the first shingled-write magnetic recording area, and the second shingled-write magnetic recording area in respective different directions in a radial direction, while overlapping tracks.

11. The magnetic disk device according to claim 10, further comprising:
control means which is to be connected to an external device, and performs control so that the head records the data in the third area in accordance with a recording command transmitted from the external device, and records the data recorded in the third area in the first area or the second area.

12. The magnetic disk device according to claim 11, wherein:
the control means is a system controller including an R/W channel, a hard disk controller, and a microprocessor.

13. The magnetic disk device according to claim 10, wherein:
the head records the data from the center side toward the outer circumference side of the disk of the first shingled-write magnetic recording area.

14. A storage system comprising:
the magnetic disk device according to claim 10; and
a sever connected to the magnetic disk device.
